(19) United States
(12) Patent Application Publication
(10) Pub. No.: US 2010/0198644 A1
(43) Pub. Date: Aug. 5, 2010

(54) System and method for computer-aided coordination of presentation events

(75) Inventors: April H. Renfro, Florence, TX (US); Marisol Bustamante, Austin, TX (US); Lynne M. Smith, Austin, TX (US)

Correspondence Address: Baker Botts L.L.P, 910 Louisiana Street, One Shell Plaza, HOUSTON, TX, 77002, US

(73) Assignee: DELL PRODUCTS L.P.

(21) Appl. No.: 12/322,603

(22) Filed: Feb. 4, 2009

(51) Int. Cl. G06Q 10/00

(52) U.S. Cl. 705/9; 705/8

(57) ABSTRACT

A system and method for the automated scheduling, coordination, and management of meetings, briefings, and other presentations. The meeting coordination application described herein is a centralized system for meeting planning. The meeting coordination application receives data from a customer database, a human resources database, and a scheduling database. On the basis of this data, the meeting coordination application proposes or selects presenters for the meeting. The meeting coordination application selects the presenters on the basis of their personal availability and their knowledge base as compared to the topics proposed by the customer for the meeting. The meeting coordination also acts as a logistical tool for scheduling the meeting, coordinating tasks relating to reserving the meeting space, generating catering instructions, arranging and confirming transportation for meeting attendees, conducting a post-meeting survey, and collecting survey responses and other information to update a historical database describing organizational meetings.

### TECHNICAL FIELD

The present disclosure relates generally to the operation of computer systems and information handling systems, and, more particularly, to a system and method for computer-aided coordination of presentation events.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

In some organizations, one or more information handling system or computer system may be used to scheduling meetings and other presentations. Too often, however, the scheduling of meetings and presentations in a large organization is poorly coordinated and haphazard process. In many large organizations, the resources required to arrange for an effective meeting are distributed across the information technology and database resources of the organization, making it difficult for a meeting planner to access the human resources, site scheduling resources, and content resources required to schedule a presentation or meeting. In addition, the software productivity tools required to arranged a meeting are not consolidated into a single software tool or location. Instead, a meeting coordinator would have to use several different software tools, including e-mail tools, database tools, calendaring tools, and word processing tools, none of which are specifically designed for arranging and coordinating a meeting or presentation in a large organization. In addition, the organization may not be aware of all of the presenters within the organization, the availability of each presenter, and the topics on which those presenters are able to speak. As a result, the organization often misses opportunities to have a presenter speak on a topic because the organization is not able to access the presenter's calendar or is not aware that the presenter can speak on a certain topic.

### SUMMARY

In accordance with the present disclosure, a system and method for the automated scheduling, coordination, and management of meetings, briefings, and other presentations. The meeting coordination application described herein is a centralized system for meeting planning. The meeting coordination application receives data from a number of sources in an organization, including a customer database, a human resources database, and a scheduling database. On the basis of this data, the meeting coordination application proposes or selects presenters for the meeting. The meeting coordination application selects the presenters on the basis of their personal availability and their knowledge base as compared to the topics proposed by the customer for the meeting. The meeting coordination also acts as a logistical tool for scheduling the meeting, coordinating tasks relating to reserving the meeting space, generating catering instructions, arranging and confirming transportation for meeting attendees, conducting a post-meeting survey, and collecting survey responses and other information to update a historical database describing organizational meetings.

The system and method disclosed herein is technically advantageous because it provides a meeting coordination tool that is centralized and automated. The centralized nature of the tool provides a central repository for a number of tasks necessary for initiating, coordinating, and managing a meeting or other presentation. In the absence of this tool, meeting coordination would have to be performed by a number of disparate tools. The meeting coordination tool described herein is also advantageous because it is automated. The system selects presenters and performs other meeting coordination tasks in an automated fashion, thereby performing the tasks quickly and relieving a human operator of the need to perform each meeting coordination task. The meeting coordination application is flexible in that it can receive information from and distribute information through the existing information technology processes of the organization. Thus, although the meeting coordination tool is centralized and automated in nature, it can be seamless integrated with the existing information technology systems of the organization. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of a meeting coordination application and its relationship to data sources for the application;

FIG. 2 is a flow diagram of the operation of meeting coordination application;

FIG. 3 (comprised of FIGS. 3A, 3B, 3C, and 3D) is a diagram of a web page of a scheduling tool of the meeting coordination application;

FIG. 4 (4A, 4B, 4C, and 4D) is a diagram of a web page of client and organizational contacts within the meeting coordination application;

FIG. 5 (comprised of FIGS. 5A, 5B, 5C, and 5D) is a diagram of a confirmation web page within the meeting coordination application;

FIG. 6 (comprised of FIGS. 6A, 6B, and 6C) is a diagram of a web page for adding or modifying the list of attendees within the meeting coordination application;

FIG. 7 is a diagram of a web page of identification and travel information for meeting participants within the meeting coordination application;

FIG. 8 (comprised of FIGS. 8A and 8B) is a diagram of a customer feedback web page within the meeting coordination application; and

FIG. 9 (comprised of FIGS. 9A and 9B) is a diagram of a feedback and notes web page within the meeting coordination application.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

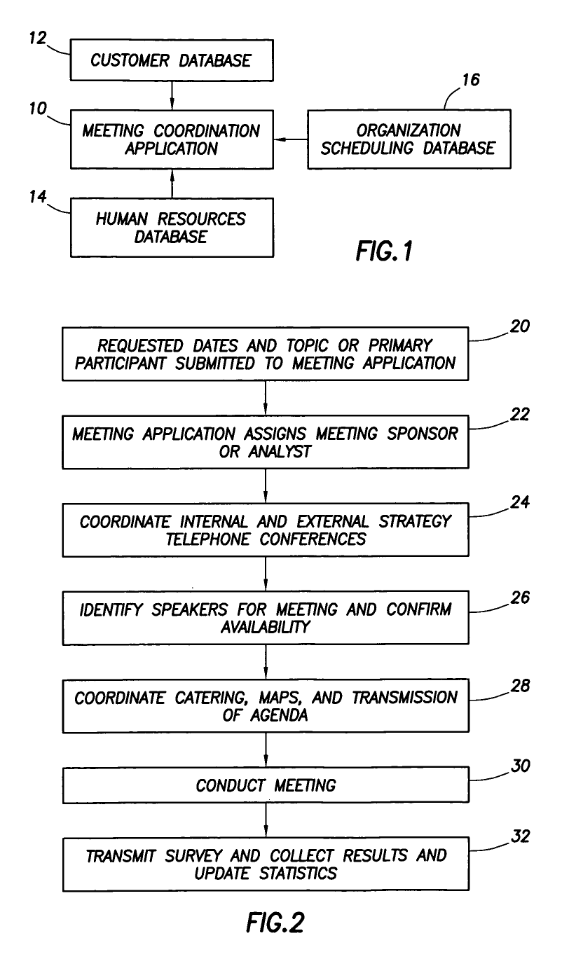

Shown in FIG. 1 is a diagram of a meeting coordination application for an organization with reference to the sources of data within the organization for the meeting coordination application. Meeting coordination application 10 is a software tool that receives information from a customer database 12, a human resources database 14, and an organization scheduling database 16. Customer database 12 includes customer information, including the names and addresses of customer representatives and each customer's purchasing history with the organization. Customer database 12 may also include a history of sales presentations made to the customer, including an identification of the employees making the organization as well as the presentation materials or topics presented to the customer. Customer database 12 may also include competitive intelligence information concerning the products or services that the customer purchases from competitors of the organization.

Human resources database 14 includes information concerning each employee or consultant of the organization, including the position or title of the employee, the employee's contacts, information concerning the employee's relationships with the organization's customer, and the employee's knowledge base. An employee's knowledge base includes the identification of topics on which the employee is able to make presentations to customers. Organization scheduling database 16 includes information about the daily schedules of the organization's conference rooms and other meeting venues, and the individual daily schedules of each of its employees. The daily schedule of each employee could also be included in human resources database 14. In operation, meeting coordination application 10 is able to access each of the databases to include data that is manipulated in order to provide a suite of meeting coordination services.

Shown in FIG. 2 is a flow diagram that depicts the operation of meeting coordination application 12. At step 20, a user of the application inputs a set of dates and times, a meeting, topic, or a meeting participant (such as a customer), or some combination of these inputs to the meeting coordination application. The meeting coordination assigns a meeting sponsor or analyst to the proposed meeting (step 22). The meeting coordinator or analyst will act as the primary meeting organizer for coordination functions that cannot be performed on an automated basis through the meeting coordination application. At step 24, the meeting coordinator or analyst will conduct a set of internal and external telephone conferences to learn more detailed information about the planned meeting. The internal telephone conference will typically include the person who first initiated the meeting at step 20 and employees of the organization who are familiar with the customer or target of the meeting or the product being presented to the customer. The external telephone call will involve the customer or target and will involve a question and answer session in which the customer identifies its goals for the meeting, including participants and topics for the meeting. The identification of participants for each of the internal and external telephone calls will be made through the customer database 12 and the human resources database 14.

At step 26, the meeting coordination application identifies speakers for the meeting and confirms the availability of those speakers. The identification of speakers is made by cross-referencing the topics of the meeting and the customer or target of the meeting with the human resources database. For example, if the requested meeting topic is storage products, the meeting coordination application will identify from the human resources database a set of speakers who have a knowledge of storage products. From this set of possible speakers, the meeting coordination application will identify speakers who have some familiarity or contact with the customer or target. The list of possible speakers will be presented to the meeting analyst, who will select one or more speakers. The list of possible speakers may include the times when each speaker is available. Alternatively, the list of possible speakers will only include speakers who are available during the time selected for the meeting. Once the meeting analyst identifies the set of speakers for the meeting, the meeting coordination application confirms the availability of the speakers by blocking out the time of the meeting in the schedule of each selected speaker through the organization scheduling database. In addition, once the time of the meeting is set, which may depend on the customer's availability and the scheduling of the organization's employees, the time and precise location of the meeting may be confirmed and blocked out through the meeting coordination application and the organization scheduling database. The meeting coordination application may choose the meeting space from the meeting from a set of available meeting rooms. The choice of the appropriate meeting room may depend on the number of participants expected in the meeting and the information technology requirements, if any, for the meeting.

At step 28, the meeting coordination application transmits a map (or driving directions) and an agenda to each participant in the meeting, including all employee participants and customer participants. The meeting analyst can also use the meeting coordination application to coordinate the catering needs for the meeting. The meeting itself is conducted at step 30. Following the conclusion of the meeting, the meeting coordination application transmits a survey to the meeting participants. The meeting coordination application collects the results of the survey and updates a set of statistics concerning meetings hosted by the organization. These statistics may include the names of the participants, the topics presented, the survey results, and the date of the meeting, among other possible data points.

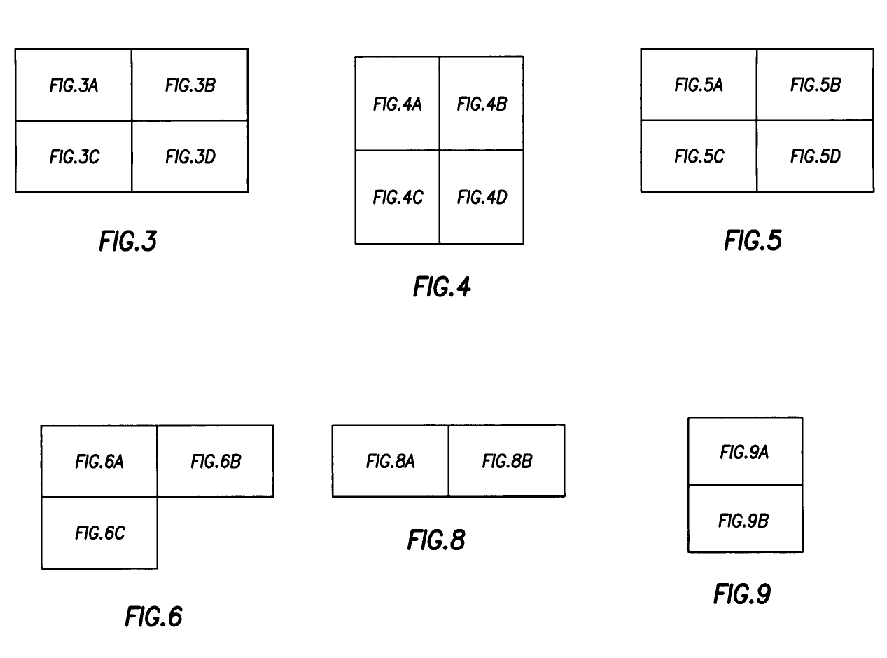

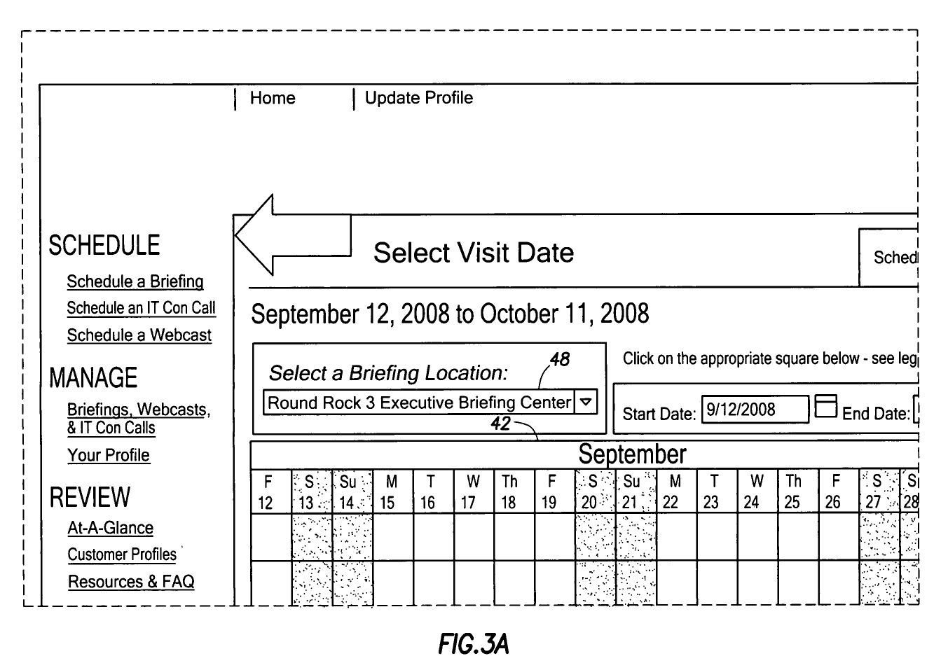

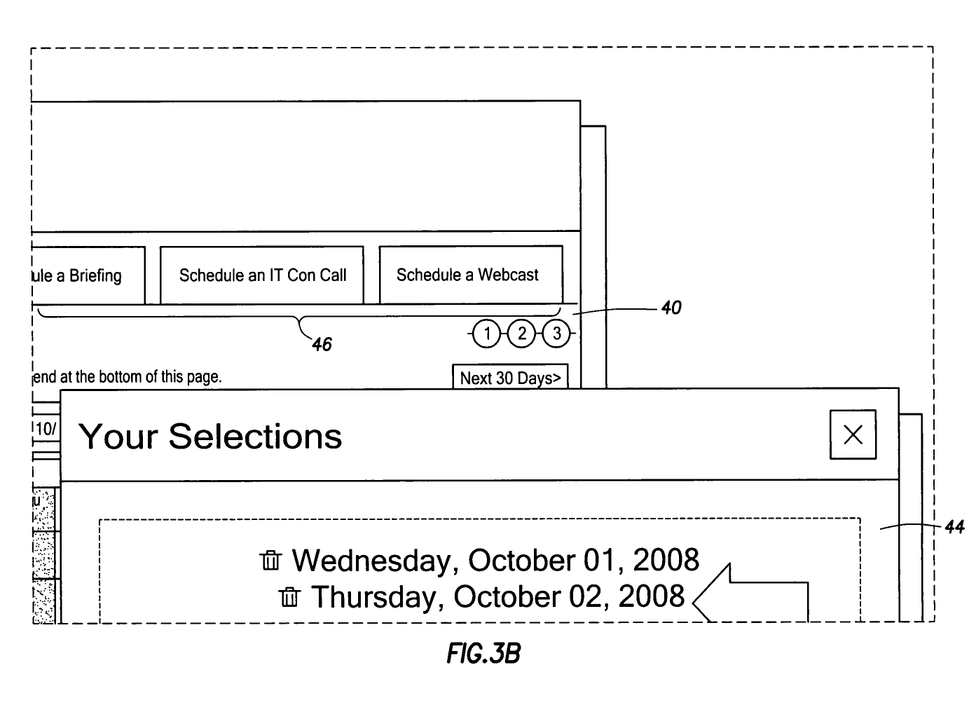

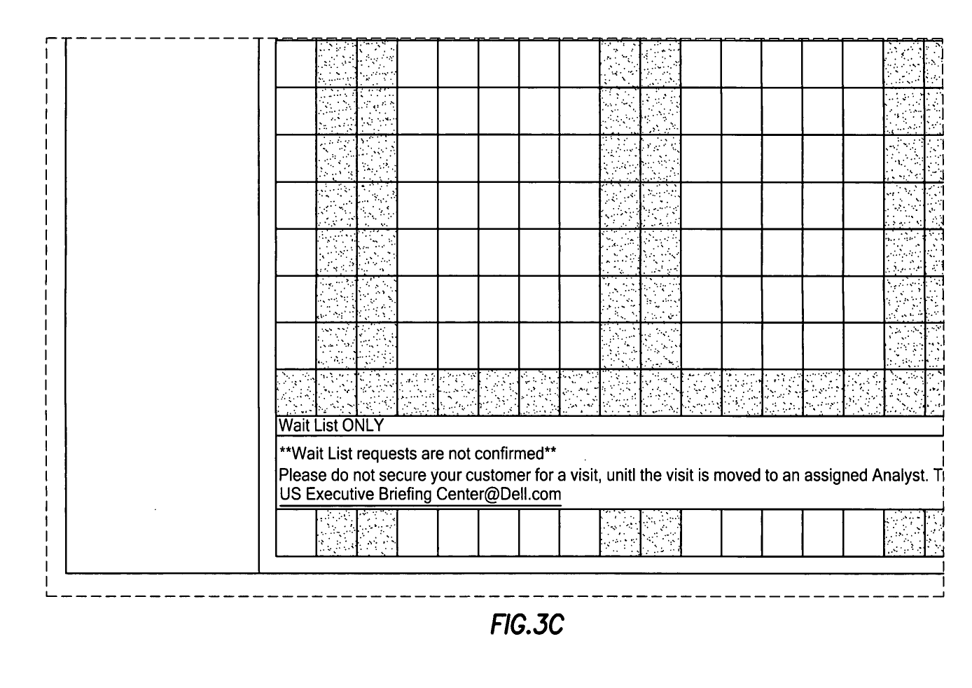

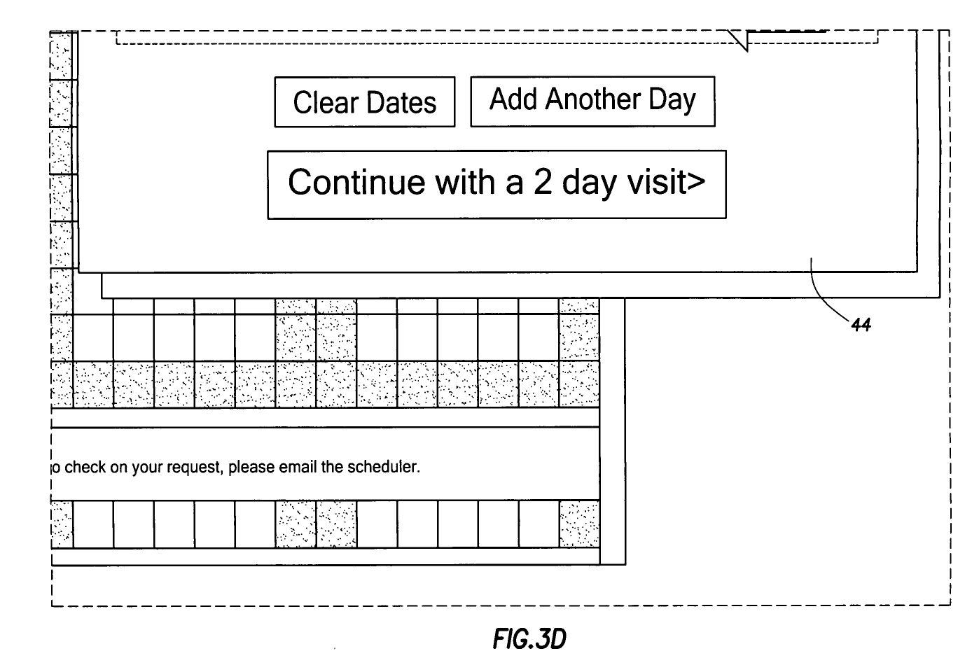

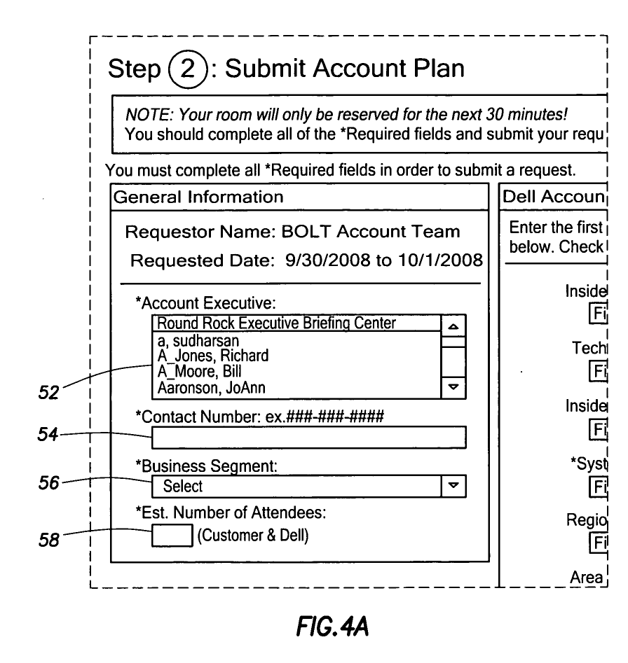

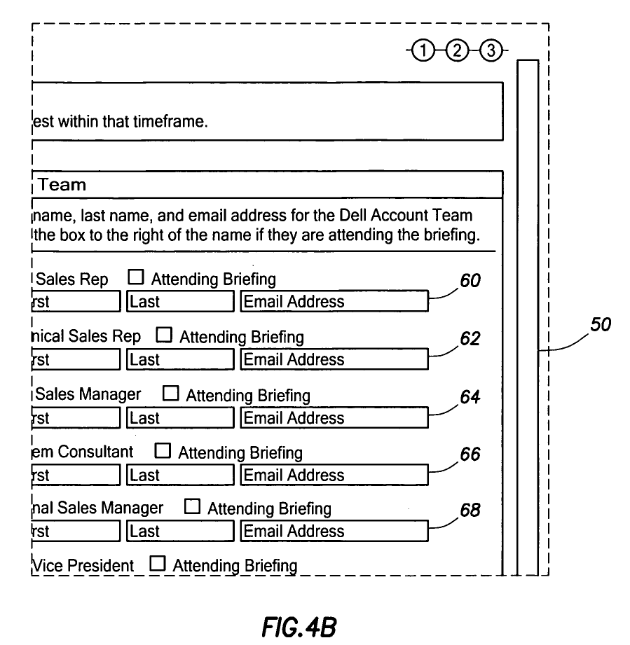

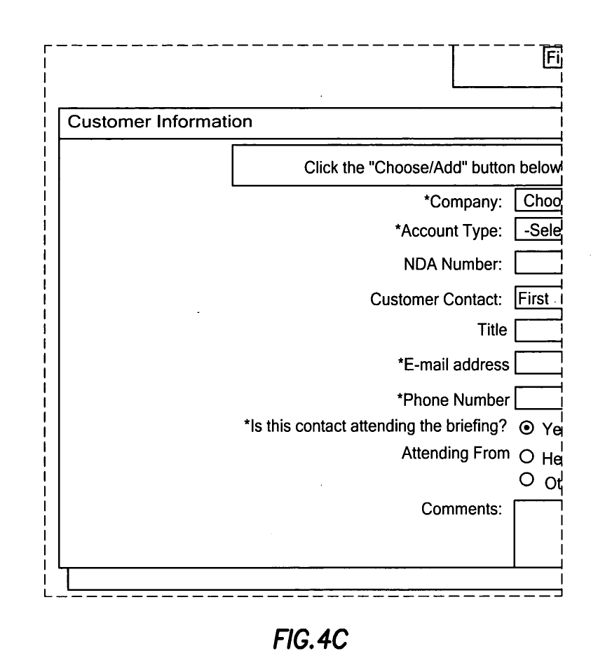

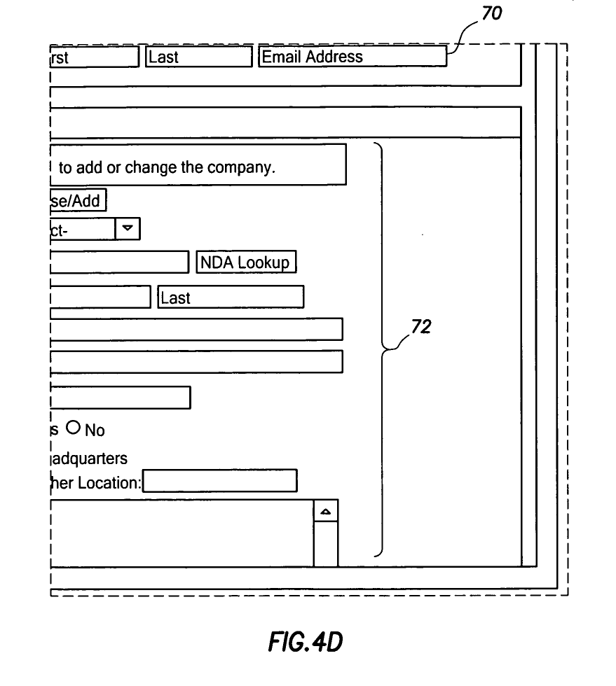

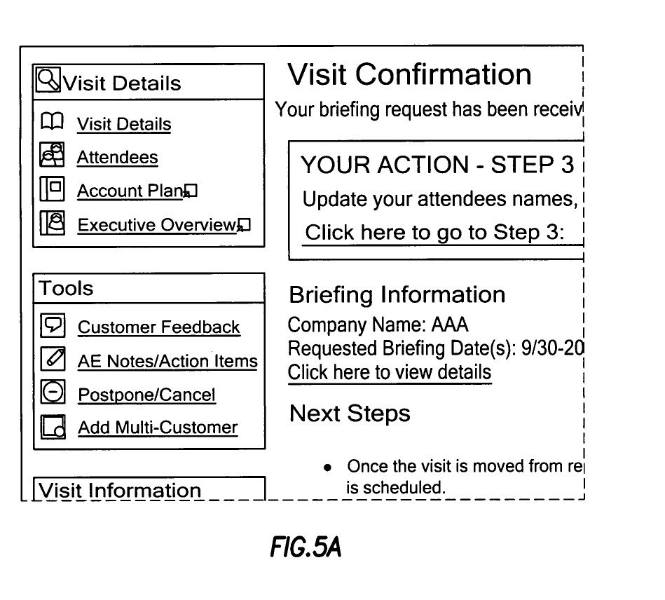

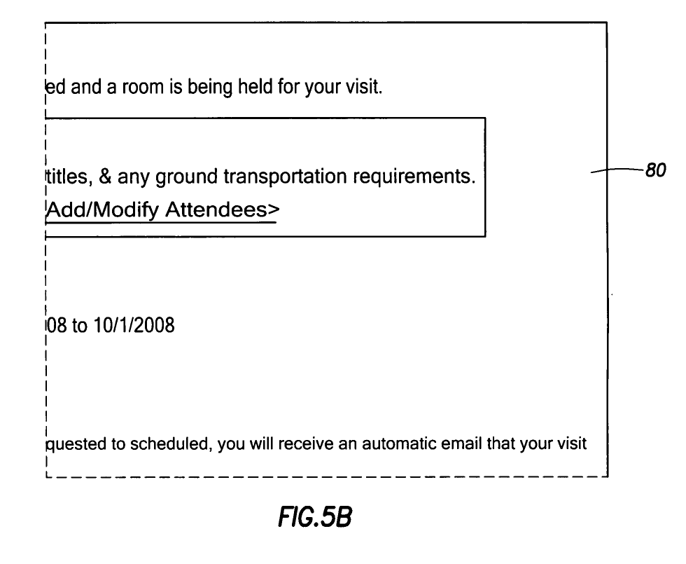

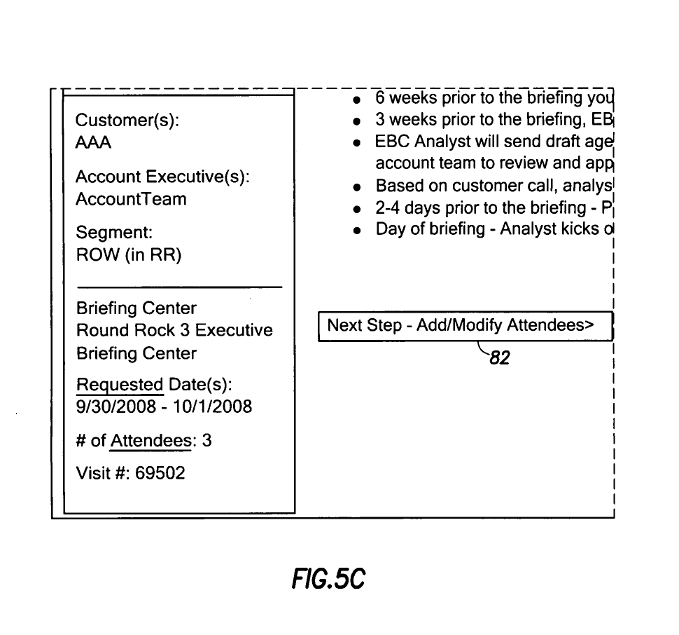

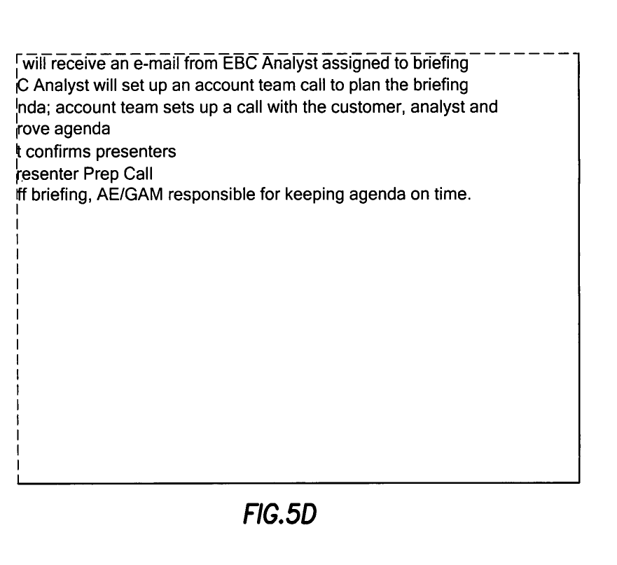

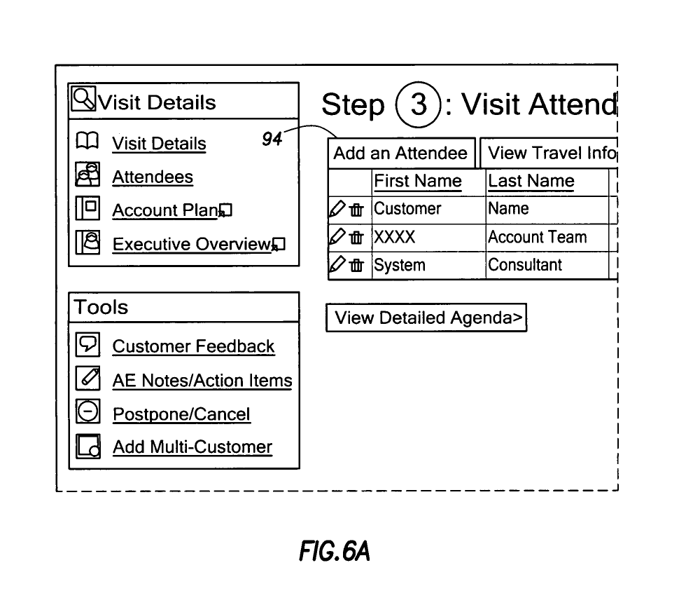

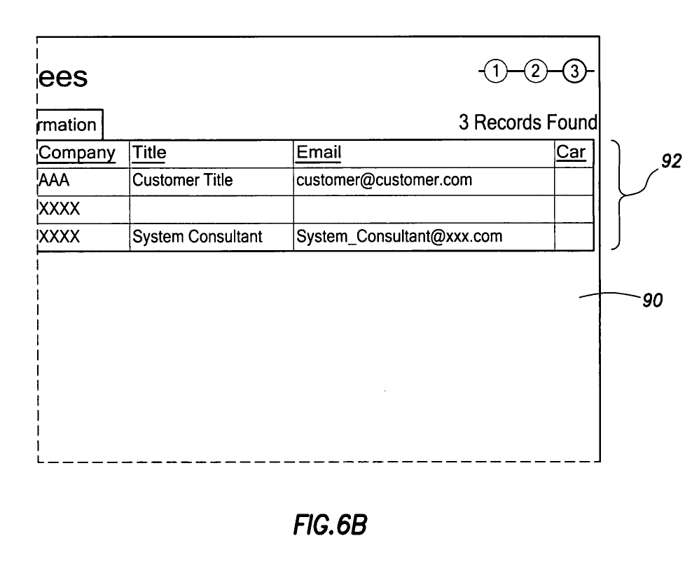

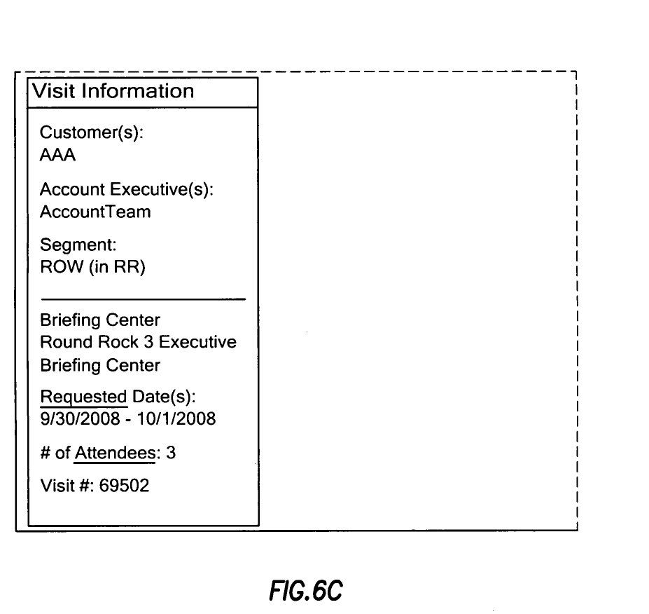

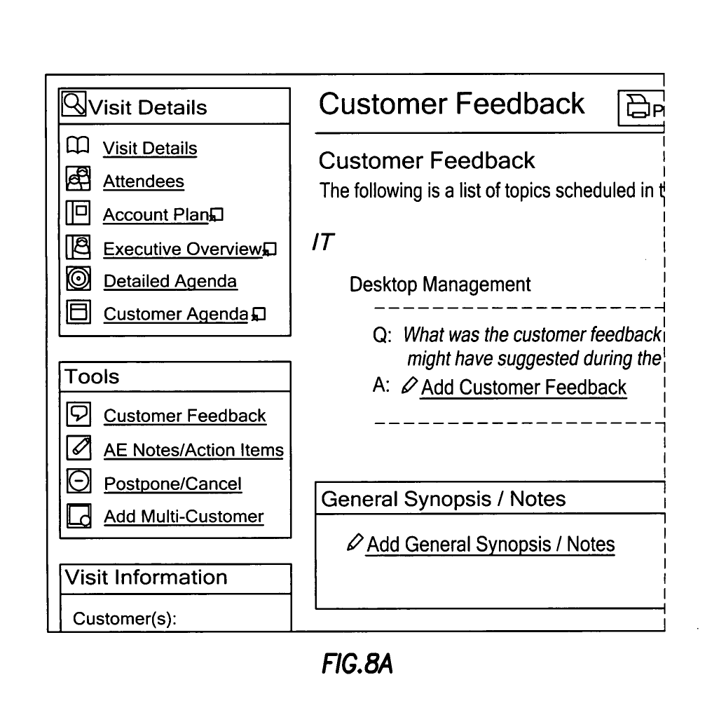

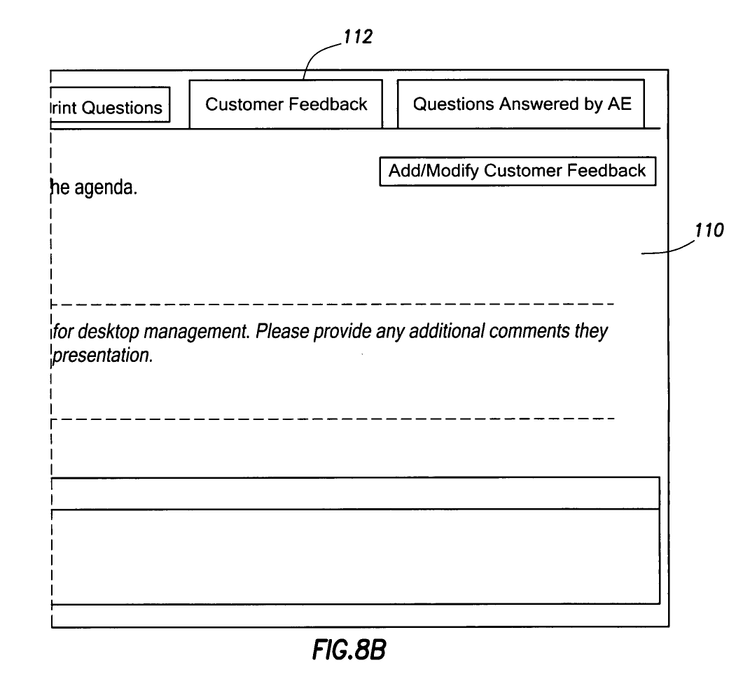

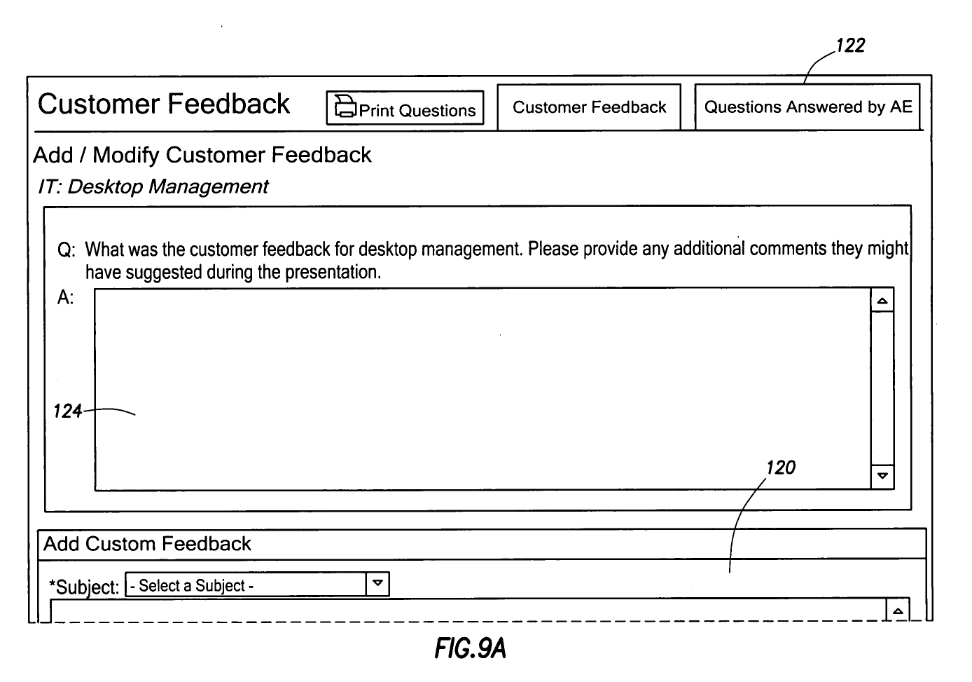

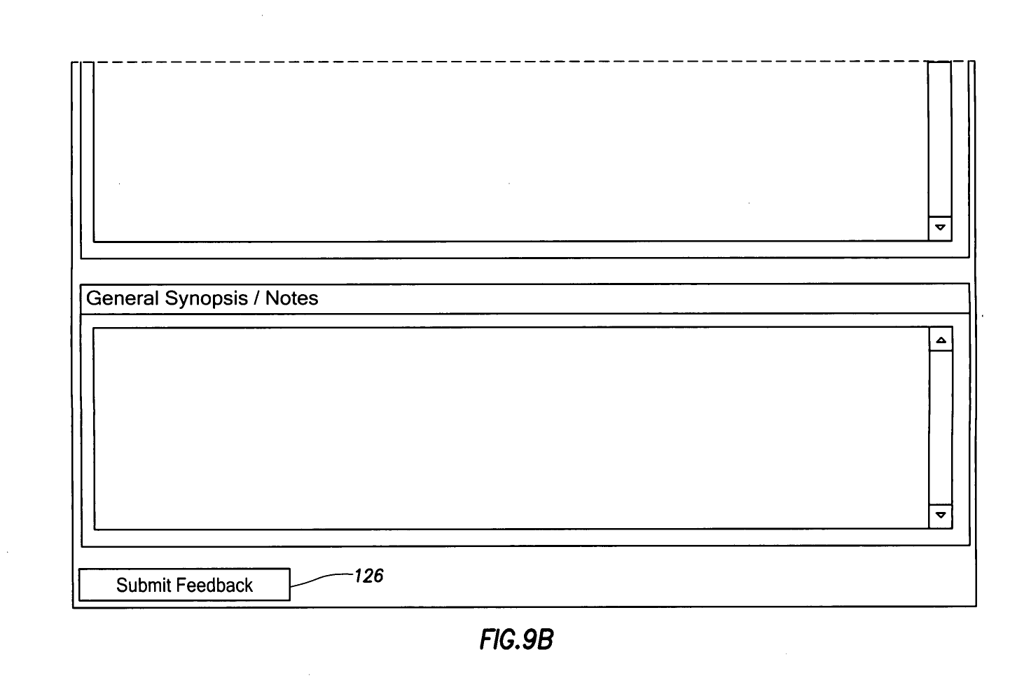

FIGS. 3-9, including subparts, are a series of web page diagrams that depict the steps of coordinating a meeting using the meeting coordination application. As indicated in the attached drawings, FIG. 3 is comprised of FIGS. 3A, 3B, 3C, and 3D; Figure is comprised of FIGS. 4A, 4B, 4C, and 4D; FIG. 5 is comprised of FIGS. 5A, 5B, 5C, and 5D; FIG. 6 is comprised of FIGS. 6A, 6B, and 6C; FIG. 8 is comprised of FIGS. 8A and 8B; and FIG. 9 is comprised of FIGS. 9A and 9B. The arrangement of each set of subfigures is shown.

FIG. 3 (comprised of FIGS. 3A, 3B, 3C, and 3D) is a web page 40 that shows depicts a scheduling tool. A user of the meeting coordination application selects the preferred time of the meeting using the tools of web page 40. Tabs 46 allow the user to select between the types of meetings (briefing, conference call, or webcast) that can be scheduled through the meeting coordination application. A user can select a time and date for the meeting highlighting a preferred time and date on calendar 42. Once a preferred time and date is selected by the user, a pop-up box 44 identifies the selected time for the user. Page 40 also include a pull down menu for selecting the preferred location of the meeting.

After the user enters scheduling information for the proposed meeting, the user next enters a set of information concerning the client and the organizations contacts with the client in the web page 50 of FIG. 4 (comprised of FIGS. 4A, 4B, 4C, and 4D). Under the heading General Information, the requester and date of the meeting is shown. The user identifies himself through pull down menu 52 and additionally provides his or her contact information (box 54) and business segment (box 56). At box 58, the user identifies the expected number of attendees at the meeting. At boxes 60-70, the user identifies the account team associated with the customer, including, in this example, the inside sales representative (box 60), the technical sales representative (box 62), the inside sales manager (box 64), the system consultant (box 66), the regional sales manager (box 68), and the area vice-president (box 70). The precise roles of the internal contact team for the client will vary from organization to organization. At step 72, the user enters information concerning the customer that will be the subject of the meeting. This information includes the name of the company, a contact point at the company, and other identifying information.

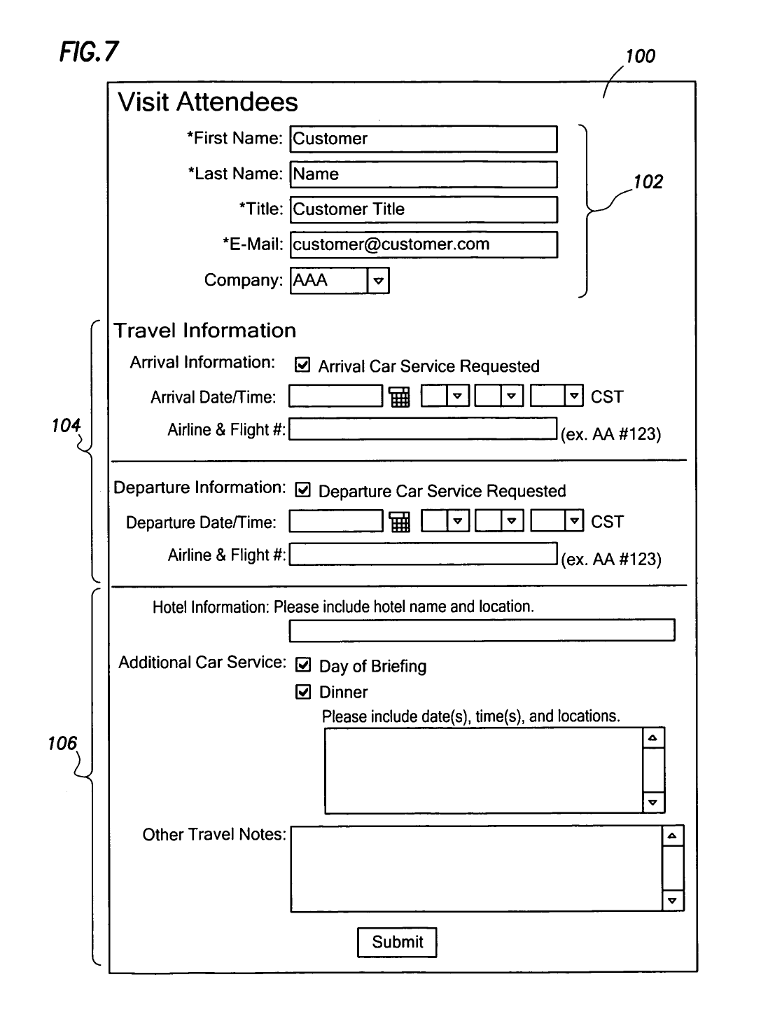

Web page 80 of FIG. 5 (comprised of FIGS. 5A, 5B, 5C, and 5D) is a confirmation page that collects and displays a set of information concerning the meeting under the heading Visit Information. Button 82 allows the user to add or modify the attendees of the meeting. Web page 90 of FIG. 6 (comprised of FIGS. 6A, 6B, and 6C) allows a user to add an attendee. This functionality is useful for adding the names of persons associated with the customer who will attend the meeting. An attendee can be added through the Add an Attendee tab 94. Rows 92 include a set of descriptive information for each attendee. The web page 100 of FIG. 7 is a detailed set of identifying and traveling information for each external attendee. Fields 102 include a set of personal identifiers for each attendee. The fields in boxes 104 include travel information, and the fields in boxes 106 include hotel information for each attendee.

Shown in FIG. 8 (comprised of FIGS. 8A and 8B) is a web page 110 that includes a customer feedback tab 112. Customer feedback may include customer feedback that is collected in advance of the meeting or the customer feedback of web page 110 may comprise customer feedback that is collected during the meeting or in response to a post-meeting survey. Depending on the time of its entry into the meeting coordination application, customer feedback may be used to prepare for the meeting or may be used to work with the customer following the conclusion of the meeting. Web page 126 of FIG. 9 (comprised of FIGS. 9A and 9B) includes additional customer feedback and notes entry fields. Tab 122 identifies questions answered by the account executive before, during, or following the meeting. Field 124 is a location for entering responses to customer feedback and fields 120 include locations for custom feedback, such as feedback tailored for the customer, and notes.

Although the present disclosure has been described in detail, it should be understood that various changes, substitutions, and alterations can be made hereto without departing from the spirit and the scope of the invention as defined by the appended claims.

What is claimed is:

1. A method for the automated coordination of a meeting involving a customer of an organization, comprising the steps of:
receiving at a meeting coordination application a set of data concerning the customer;
receiving at the meeting coordination application a set of data concerning the human resources of the organization; and
receiving at the meeting coordination application a set of data concerning the scheduling resources of the organization; and
using the data concerning the customer, human resources of the organization, and scheduling resources of the organization at the meeting coordination application to identify a set of available participants for the meeting.

2. The method for the automated coordination of a meeting of claim 1, wherein the human resources of the organization include an identification of topics on which employees of the organization can speak, and wherein the step of using the data comprises the step of selecting a speaker from the organization based on a comparison of a meeting topic selected by the customer and the identified topics on which employees can speak.

3. The method for the automated coordination of a meeting of claim 1, wherein the set of available participants for the meeting are selected on the basis of a comparison the schedules of each employee with the proposed time of the meeting.

4. The method for the automated coordination of a meeting of claim 1, further comprising the step of selecting a location for the meeting on the basis of data concerning the scheduling resources of the organization, wherein such data includes the availability of meeting rooms in the organization.

5. The method for the automated coordination of a meeting of claim 1, further comprising the step of issuing from the meeting coordination application a set of confirmatory messages to confirm the attendance of each participant selected for the meeting.

6. The method for the automated coordination of a meeting of claim 5, wherein the confirmatory messages include an identification of travel arranges for each participants in the meeting.

7. The method for the automated coordination of a meeting of claim 6, further comprising the step of transmitting from the meeting coordination application following the meeting a survey to the participants in the meeting.

8. The method for the automated coordination of a meeting of claim 7, further comprising the step of collecting at the meeting coordination application a set of data concerning the participants and topics at the meeting and updating a set of historical data concerning the history of meetings of the organization.

9. A meeting coordination system, comprising:
a meeting coordination running on a computer system;
a customer database;
a human resources database;
a scheduling database;
wherein the meeting coordination application is operable to receive data from the customer database, human resources database, and scheduling database, and schedule a meeting on an automated basis, wherein the participants and the timing of the meeting is governed by data received from the customer database, human resources database, and scheduling database.

10. The meeting coordination system of claim 9, wherein the meeting coordination application selects participants for the meeting and the selection of participants is dependent upon a set of topics suggested by the customer.

11. The meeting coordination system of claim 10, wherein the meeting coordination application selects participants for the meeting and the selection of participants is dependent upon the personal schedule of those persons associated with the organization who are qualified to speak on the set of topics suggested by the customer.

12. The meeting coordination system of claim 9, wherein the meeting coordination application selects a location for the meeting and the selection of a location for the meeting is dependent upon the availability of meeting space at the organization as defined by the scheduling database

13. The meeting coordination system of claim 9, wherein the meeting coordination application is operable to transmit on an automated basis a confirmatory message to each selected meeting participant concerning the time and location of the meeting.

14. The meeting coordination system of claim 9, wherein the meeting coordination application is operable to transmit on an automated basis a survey to one or more of the meeting participants following the conclusion of the meeting.

15. The meeting coordination system of claim 9, wherein the meeting coordination application is operable to collect data concerning the topics, participants, and survey results and update a set of historical data concerning the meetings of the organization.

16. A method for scheduling a meeting with a customer of an organization at a predetermined time, comprising:
receiving at a meeting coordination tool a set of information concerning the customer, the proposed topics for the customer, and the human and facility resources of the organization;
comparing the proposed topics with the human resources of the organization to identify a set of speakers who are available at the predetermined time and are able to speak on the proposed topics;
issuing a set of commands to confirm the speakers and select and reserve the appropriate facility resources of the organization.

17. The method for scheduling a meeting of claim 16, wherein the facility resources comprise the meeting space of the organization and the selection of the appropriate meeting space comprises selecting a meeting space that is available and that can accommodate the number of expected participants in the meeting and the information technology needs of the meeting.

18. The method for scheduling a meeting of claim 16, wherein the human resources of the organization include persons associated with the organization and topics on which each such person can speak.

19. The method for scheduling a meeting of claim 16, further comprising the step of transmitting a set of confirmation notices to the customer to confirm the time, location, and travel arrangements of the customer.

20. The method for scheduling a meeting of claim 19, further comprising the step of transmitting a survey to the customer following the meeting and collecting the results of the survey.
